(19) United States
(12) Patent Application Publication
(10) Pub. No.: US 2022/0013998 A1
(43) Pub. Date: Jan. 13, 2022

(54) Cable Processing System

(71) Applicants: Tyco Electronics (Shanghai) Co. Ltd., Shanghai (CN); TE Connectivity Services GmbH, Schaffhausen (CH)

(72) Inventors: An Yang, Shanghai (CN); Lvhai Hu, Shanghai (CN); Roberto Francisco-Yi Lu, Bellevue, WA (US)

(73) Assignees: Tyco Electronics (Shanghai) Co. Ltd., Shanghai (CN); TE Connectivity Services GmbH, Schaffhausen (CH)

(21) Appl. No.: 17/370,486

(22) Filed: Jul. 8, 2021

(30) Foreign Application Priority Data
Jul. 9, 2020 (CN) 202010656461.X

(51) Int. Cl. H02G 1/12

(52) U.S. Cl. CPC H02G 1/12

(57) ABSTRACT

A cable processing system includes a first rotator rotatable about a first axis, a first fixture mounted on the first rotator for clamping one end of the cable fed to the first rotator, and a first processing device arranged near the first rotator for processing the one end of the cable. The first rotator rotates the clamped end of the cable to the first processing device such that the one end of the cable may be processed by the first processing device.

### CROSS-REFERENCE TO RELATED APPLICATIONS

This application claims priority under 35 U.S.C. § 119 to Chinese Patent Application No. 202010656461.X, filed on Jul. 9, 2020, the entire disclosure of which is incorporated herein by reference.

### FIELD OF THE INVENTION

The present disclosure relates to a cable processing system.

### BACKGROUND

In the related art, before connecting a cable to a connector, two ends of the cable need to be processed. Currently, however, there is no processing system that can automatically process the ends of the cable in an assembly line. Thus, the processing of the cable ends must be performed manually, or only semi-automatically, resulting in low processing efficiency and increased costs.

### SUMMARY

According to an embodiment of the present disclosure, a cable processing system includes a first rotator rotatable about a first axis, a first fixture mounted on the first rotator for clamping one end of the cable fed to the first rotator, and a first processing device arranged near the first rotator for processing the one end of the cable. The first rotator rotates the clamped end of the cable to the first processing device such that the one end of the cable may be processed by the first processing device.

### BRIEF DESCRIPTION OF THE DRAWINGS

The invention will now be described by way of example with reference to the accompanying Figures, of which:

FIG. 1 shows a schematic view of a cable processing system according to an exemplary embodiment of the disclosure in which one end of a cable is clamped onto a first fixture;

FIG. 2 shows a schematic view illustrating that the clamped end of the cable is rotated to a first processing device by a first rotator;

FIG. 3 shows a schematic view illustrating that the cable is further fed forward after the one end of the cable is processed such that the cable passes through a cable cutter and is cut by the cable cutter;

FIG. 4 shows a schematic view illustrating that the other end of a cable segment cut off from the cable is rotated by a second rotator rotates to a second processing device;

FIG. 5 shows a schematic view of a cable processing system according to another exemplary embodiment of the disclosure in which one end of a cable is clamped onto a first fixture;

FIG. 6 shows a schematic view illustrating that the clamped end of the cable is rotated to a first processing device by a first rotator;

FIG. 7 shows a schematic view illustrating that the cable is coiled around a pillar and the coiled cable is cut;

FIG. 8 shows a schematic view illustrating that the first rotating body and the second rotating body rotate together to rotate the other end of a cable segment, which is cut off from the cable, to a second processing device; and

FIG. 9 shows a schematic view illustrating that the processed cable segment is grasped onto a conveyor by an automatic grasp device.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a cable processing system includes a first rotator rotatable about a first axis, a first fixture mounted on the first rotator and configured to clamp one end of the cable fed to the first rotator, and a first processing device arranged near the first rotator and configured to process the one end of the cable. The first rotator rotates the clamped end of the cable to the first processing device such that the one end of the cable may be processed.

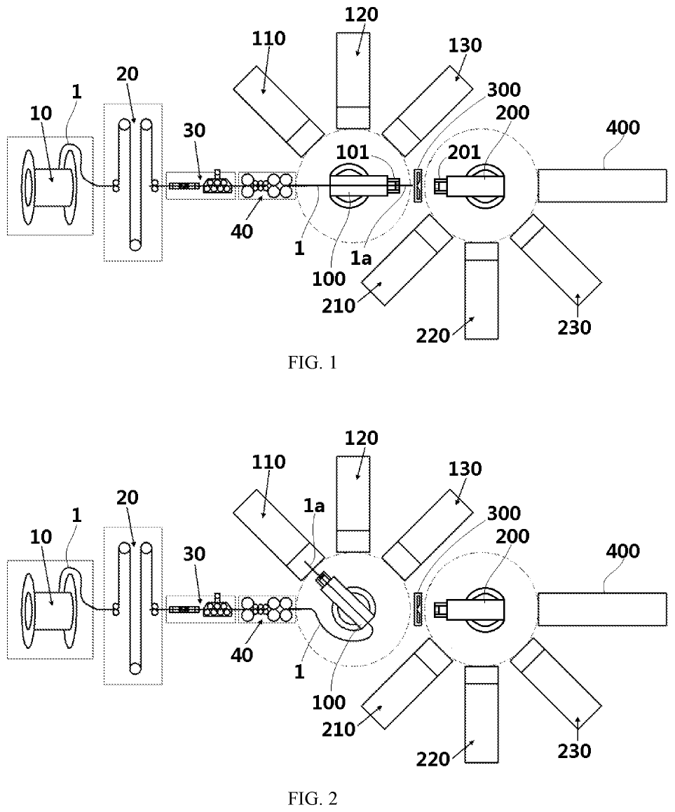

FIG. 1 shows a schematic view of a cable processing system according to an exemplary embodiment of the disclosure in which one end of a cable is clamped onto a first fixture. FIG. 2 shows a schematic view illustrating that the clamped end of the cable is rotated to a first processing device by a first rotator.

As shown in FIGS. 1 and 2, in the illustrated embodiment, a cable processing system includes a first rotator 100, a first fixture 101 and a first processing device 110, 120, 130. The first rotator 100 is rotatable about a first axis. The first fixture 101 is mounted on the first rotator 100 for clamping one end 1a of the cable 1 fed to the first rotator 100. The first processing device 110, 120, 130 is arranged near the first rotator 100, for processing the one end 1a of the cable 1.

As shown in FIGS. 1 and 2, in the illustrated embodiment, the first rotator 100 is adapted to rotate the clamped end 1a of the cable 1 to the first processing device 110, 120, 130 such that the one end 1a of the cable 1 can be processed by the first processing device.

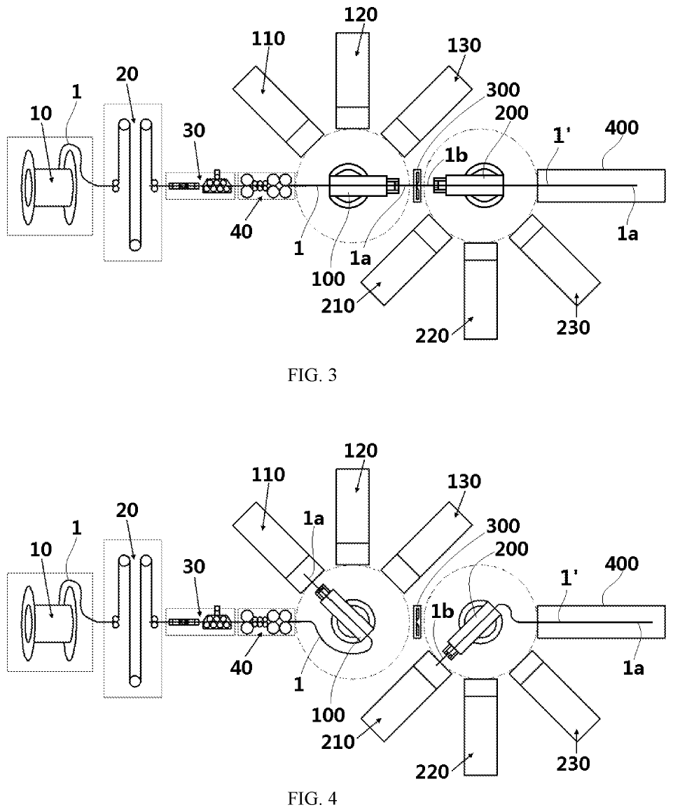

FIG. 3 shows a schematic view illustrating that the cable is further fed forward after the one end of the cable is processed such that the cable passes through a cable cutter and is cut by the cable cutter. FIG. 4 shows a schematic view illustrating that the other end of a cable segment cut off from the cable is rotated by a second rotator rotates to a second processing device.

As shown in FIGS. 1 to 4, in the illustrated embodiment, the cable processing system further includes a cable feeding device 10, 20, 30, 40 and a cable cutter 300. The cable feeding device 10, 20, 30, 40 is configured to feed the cable 1. The cable cutter 300 is configured to cut the fed cable 1. After the one end 1a of the cable 1 is processed, a segment of the cable 1 at a feed side is cut off by the cable cutter 300 to obtain a cable segment 1′ having a predetermined length and one processed end 1a.

As shown in FIGS. 1 to 4, in the illustrated embodiment, the cable processing system further includes a second rotator 200 rotatable about a second axis, a second fixture 201 mounted on the second rotator 200 and configured to clamp the other end 1b of the cable segment 1′, and a second processing device 210, 220, 230 arranged near the second rotator 200 and configured to process the other end 1b of the cable segment 1′.

As shown in FIGS. 1 to 4, in the illustrated embodiment, the second rotator 200 is adapted to rotate the other clamped end 1b of the cable segment 1′ to the second processing device 210, 220, 230 so that the end 1b of the cable 1 can be processed by the second processing device.

As shown in FIGS. 1 to 4, in the illustrated embodiment, the cable processing system further includes a conveyor 400 for conveying the cable segment 1′ having two processed ends 1a, 1b to a predetermined position.

As shown in FIGS. 1 to 4, in the illustrated embodiment, the first processing device 110, 120, 130 includes a first stripping device 110 for stripping an outer coating over the one end 1a of the cable 1. The second processing device 210, 220, 230 includes a second stripping device 210 for stripping an outer coating over the other end 1b of the cable segment 1′.

As shown in FIGS. 1 to 4, in the illustrated embodiment, the first processing device 110, 120, 130 further includes a first braided shielding layer flaring device 120 for flaring a braided shielding layer over the one end 1a of the cable 1 outwardly by a first predetermined angle. The second processing device 210, 220, 230 also includes a second braided shielding layer flaring device 220 for flaring a braided shielding layer over the other end 1b of the cable segment 1′ outwardly by a second predetermined angle.

As shown in FIGS. 1 to 4, in the illustrated embodiment, the first processing device 110, 120, 130 further includes a first crimping device 130 for crimping a conductor of the one end 1a of the cable 1 onto a conductive terminal. The second processing device 210, 220, 230 further includes a second crimping device 230 for crimping a conductor of the other end 1b of the cable segment 1′ onto another conductive terminal.

As shown in FIGS. 1 to 4, in the illustrated embodiment, the cable feeding device 10, 20, 30, 40 includes a cable feed reel 10 around which the cable 1 to be fed is coiled.

As shown in FIGS. 1 to 4, in the illustrated embodiment, the cable feeding device 10, 20, 30, 40 further includes a conveyor 40 which includes a plurality of pairs of conveying rollers. The cable 1 is clamped between the conveying rollers, and the plurality of pairs of conveying rollers are configured to convey and feed the cable 1 forward through rotation.

As shown in FIGS. 1 to 4, in the illustrated embodiment, the cable feeding device 10, 20, 30, 40 further includes a cable buffering and tensioning device 20 arranged between the cable feed reel 10 and the conveyor 40 and adapted to temporarily store the cable of a predetermined length and apply a predetermined tension to the fed cable.

As shown in FIGS. 1 to 4, in the illustrated embodiment, the cable feeding device 10, 20, 30, 40 further includes a cable straightening device 30 arranged between the cable buffering and tensioning device 20 and the conveyor 40 to straighten the fed cable 1.

As shown in FIGS. 1 to 4, in the illustrated embodiment, each of the first rotator 100 and the second rotator 200 is a rotatable arm, and the first rotator 100 and the second rotator 200 are spaced apart from each other by a predetermined distance in a feeding direction of the cable 1.

As shown in FIGS. 1 to 4, in the illustrated embodiment, the first rotator 100 is arranged between the cable feeding device 10, 20, 30, 40 and the second rotator 200, and the cable cutter 300 is arranged between the first rotator 100 and the second rotator 200.

As shown in FIGS. 1 to 4, in the illustrated embodiment, after the one end 1a of the cable 1 is processed, the first fixture 101 is rotated to a position aligned with the second fixture 201 and opened to allow the fed cable 1 to pass through the cable cutter 300 and the second fixture 201 forwardly.

As shown in FIGS. 1 to 4, in the illustrated embodiment, the one end 1a of the cable 1 clamped on the first fixture 101 is processed by the first processing device 110, 120, 130 while the other end 1b of the cable segment 1′ clamped on the second fixture 201 is processed by the second processing device 210, 220, 230.

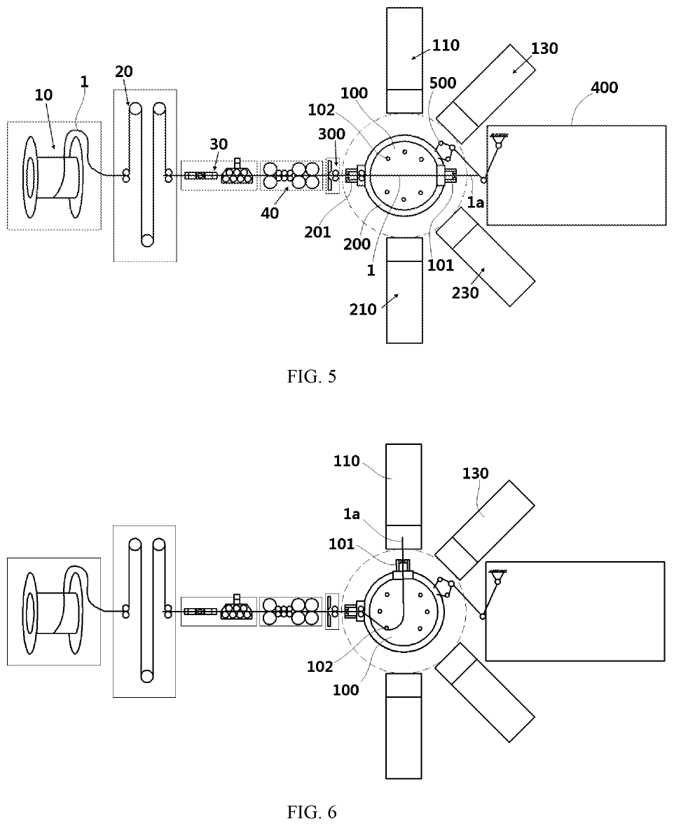

FIG. 5 shows a schematic view of a cable processing system according to another exemplary embodiment of the disclosure in which one end of a cable is clamped onto a first fixture. FIG. 6 shows a schematic view illustrating that the clamped end of the cable is rotated to a first processing device by a first rotator.

As shown in FIGS. 5 and 6, in the illustrated embodiment, a cable processing system includes a first rotator 100, a first fixture 101 and a first processing device 110, 120, 130. The first rotator 100 is rotatable about a first axis. The first fixture 101 is mounted on the first rotator 100 and configured for clamping one end 1a of the cable 1 fed to the first rotator 100. The first processing device 110, 120, 130 is arranged near the first rotator 100 and configured for processing the one end 1a of the cable 1.

As shown in FIGS. 5 and 6, in the illustrated embodiment, the first rotator 100 is suitable to rotate the clamped end 1a of the cable 1 to the first processing device 110, 120, 130 at which the one end 1a of the cable 1 is processed.

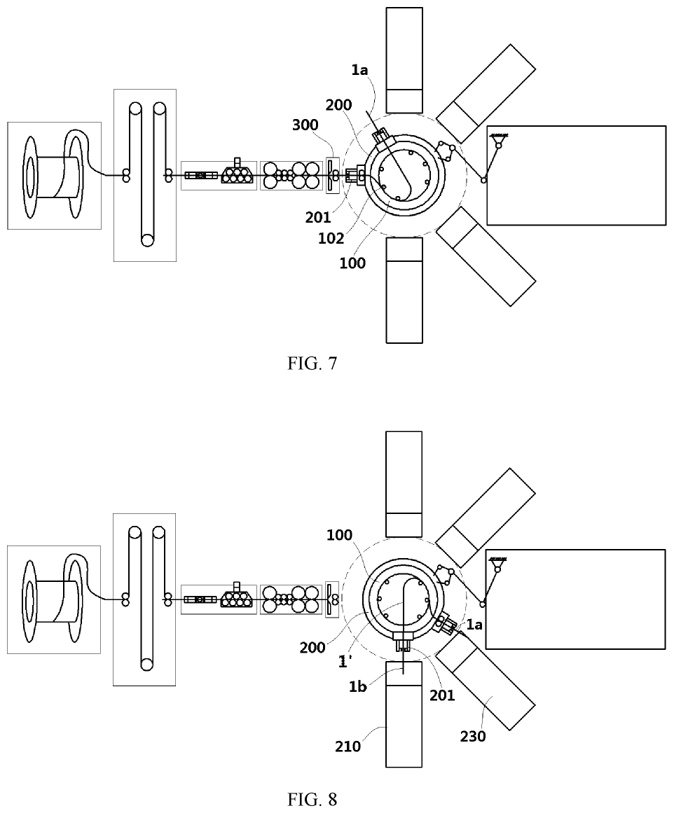

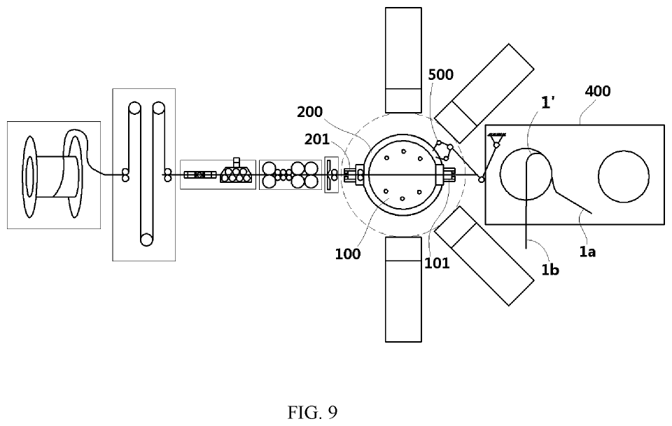

FIG. 7 shows a schematic view illustrating that the cable is coiled around a pillar and the coiled cable is cut. FIG. 8 shows a schematic view illustrating that the first rotating body and the second rotating body rotate together to rotate the other end of a cable segment, which is cut off from the cable to a second processing device.

As shown in FIGS. 5 to 8, in the illustrated embodiment, the cable processing system further includes a cable feeding device 10, 20, 30, 40 and a cable cutter 300. The cable feeding device 10, 20, 30, 40 is configured to feed the cable 1. The cable cutter 300 is configured to cut the fed cable 1. After the one end 1a of the cable 1 is processed, the cable cutter 300 cuts a segment of the cable 1 at a feed side to obtain a cable segment 1′ having a predetermined length and one processed end 1a.

As shown in FIGS. 5 to 8, in the illustrated embodiment, the cable processing system further includes: a second rotator 200 rotatable about a second axis; a second fixture 201 mounted on the second rotator 200 and configured for clamping the other end 1b of the cable segment 1′; and a second processing device 210, 220, 230 arranged near the second rotator 200 and configured for processing the other end 1b of the cable segment 1′.

As shown in FIGS. 5 to 8, in the illustrated embodiment, the second rotator 200 is suitable to rotate the other clamped end 1b of the cable segment 1′ to the second processing device 210, 220, 230 at which the other end 1b of the cable 1 is processed.

As shown in FIGS. 5 to 8, in the illustrated embodiment, the cable processing system further includes a conveyor 400 for conveying the cable segment 1′ having two processed ends 1a, 1b to a predetermined position.

As shown in FIGS. 5 to 8, in the illustrated embodiment, the first processing device 110, 120, 130 includes a first stripping device 110 for stripping an outer coating over the one end 1a of the cable 1. The second processing device 210, 220, 230 includes a second stripping device 210 for stripping an outer coating over the other end 1b of the cable segment 1′.

As shown in FIGS. 5 to 8, in the illustrated embodiment, the first processing device 110, 120, 130 further includes a first braided shielding layer flaring device 120 for flaring a braided shielding layer over the one end 1a of the cable 1 outwardly by a first predetermined angle. The second processing device 210, 220, 230 also includes a second braided shielding layer flaring device 220 for flaring a braided shielding layer over the other end 1b of the cable segment 1′ outwardly by a second predetermined angle.

As shown in FIGS. 5 to 8, in the illustrated embodiment, the first processing device 110, 120, 130 further includes a first crimping device 130 for crimping a conductor of the one end 1a of the cable 1 onto a conductive terminal. The second processing device 210, 220, 230 further includes a second crimping device 230 for crimping a conductor of the other end 1b of the cable segment 1′ onto another conductive terminal.

As shown in FIGS. 5 to 8, in the illustrated embodiment, the cable feeding device 10, 20, 30, 40 includes a cable feed reel 10 around which the cable 1 to be fed is coiled.

As shown in FIGS. 5 to 8, in the illustrated embodiment, the cable feeding device 10, 20, 30, 40 further includes a conveyor 40 which includes a plurality of pairs of conveying rollers. The cable 1 is clamped between the conveying rollers, and the plurality of pairs of conveying rollers are configured to convey and feed the cable 1 forward through rotation.

As shown in FIGS. 5 to 8, in the illustrated embodiment, the cable feeding device 10, 20, 30, 40 further includes a cable buffering and tensioning device 20 arranged between the cable feed reel 10 and the conveyor 40 and adapted to temporarily store the cable of a predetermined length and to apply a predetermined tension to the fed cable.

As shown in FIGS. 5 to 8, in the illustrated embodiment, the cable feeding device 10, 20, 30, 40 further includes a cable straightening device 30 arranged between the cable buffering and tensioning device 20 and the conveyor 40 to straighten the fed cable 1.

As shown in FIGS. 5 to 8, in the illustrated embodiment, each of the first rotator 100 and the second rotator 200 is a circular rotatable table, and the first rotator 100 and the second rotator 200 are rotatable about a common axis.

As shown in FIGS. 5 to 8, in the illustrated embodiment, the first rotator 100 is arranged directly above the second rotator 200, and the cable cutter 300 is arranged between the cable feeding device 10, 20, 30, 40 and the second rotator 200.

As shown in FIG. 5, in the illustrated embodiment, in an initial position, the first fixture 101 and the second fixture 201 are aligned with the cable cutter 300 to allow the fed cable 1 to sequentially pass through the cable cutter 300, the second fixture 201 and the first fixture 101.

As shown in FIGS. 5 to 8, in the illustrated embodiment, the cable processing system further includes a plurality of pillars 102 arranged on the first rotator 100. After the one end portion 1a of the cable 1 is processed, the first rotator 100 further rotates by a predetermined angle or a predetermined number of revolutions to coil the fed cable 1 around the pillars 102.

As shown in FIGS. 5 to 8, in the illustrated embodiment, after coiled around on the pillars 102, the fed cable 1 is cut off by the cable cutter 300 to obtain the cable segment 1′ having the predetermined length.

As shown in FIGS. 5 to 8, in the illustrated embodiment, after the fed cable 1 is cut off by the cable cutter 300, the first rotator 100 and the second rotator 200 rotate together to rotate the other clamped end 1b of the cable segment 1′ to the second processing device 210, 220, 230.

FIG. 9 shows a schematic view illustrating that the processed cable segment is grasped onto the conveyor by an automatic grasping device.

As shown in FIG. 9, in the illustrated embodiment, the cable processing system further includes an automatic grasping device 500 adapted to grasp the two processed ends 1a, 1b of the cable segment 1′ and place the grasped cable segment 1′ onto the conveyor 400.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cable processing system comprising:
a first rotator rotatable about a first axis;
a first fixture mounted on the first rotator for clamping one end of a cable fed to the first rotator; and
a first processing device arranged proximate the first rotator for processing the one end of the cable, the first rotator rotating the clamped end of the cable to the first processing device for processing by the first processing device.

2. The cable processing system according to claim 1, further comprising:
a cable feeding device for feeding the cable; and
a cable cutter for cutting the fed cable, a segment of the cable at a feed side is cut off by the cable cutter to obtain a cable segment having a predetermined length after the one end of the cable is processed.

3. The cable processing system according to claim 2, further comprising:
a second rotator rotatable about a second axis;
a second fixture mounted on the second rotator for clamping the other end of the cable segment; and
a second processing device arranged proximate the second rotator for processing the other end of the cable segment.

4. The cable processing system according to claim 3, further comprising a conveyor for conveying the cable segment having two processed ends to a predetermined position.

5. The cable processing system according to claim 3, wherein the first processing device includes a first stripping device for stripping an outer coating from the one end of the cable, and the second processing device includes a second stripping device for stripping an outer coating from the other end of the cable segment.

6. The cable processing system according to claim 5, wherein the first processing device further includes a first braided shielding layer flaring device for flaring a braided shielding layer over the one end of the cable outwardly by a first predetermined angle, and the second processing device further includes a second braided shielding layer flaring device for flaring a braided shielding layer over the other end of the cable segment outwardly by a second predetermined angle.

7. The cable processing system according to claim 5, wherein the first processing device further includes a first crimping device for crimping a conductor of the one end of the cable onto a conductive terminal, and the second processing device further includes a second crimping device for crimping a conductor of the another end of the cable segment onto another conductive terminal.

8. The cable processing system according to claim 2, wherein the cable feeding device includes a cable feed reel around which the cable to be fed is wound.

9. The cable processing system according to claim 8, wherein the cable feeding device further includes a conveyor including a plurality of pairs of conveying rollers between which the cable is clamped for conveying and feeding the cable forward.

10. The cable processing system according to claim 8, wherein the cable feeding device further includes a cable buffering and tensioning device arranged between the cable feed reel and the conveyor for temporarily storing a predetermined length of the cable and applying a predetermined tension to the fed cable.

11. The cable processing system according to claim 10, wherein the cable feeding device further includes a cable straightening device arranged between the cable buffering and tensioning device and the conveyor for straightening the fed cable.

12. The cable processing system according to claim 4, wherein each of the first rotator and the second rotator is a rotatable arm spaced apart from each other by a predetermined distance in a feeding direction of the cable.

13. The cable processing system according to claim 8, wherein the first rotator is arranged between the cable feeding device and the second rotator, and the cable cutter is arranged between the first rotator and the second rotator.

14. The cable processing system according to claim 13, wherein the first fixture is adapted to, after the one end of the cable is processed, be rotated to a position aligned with the second fixture and opened to allow the fed cable to pass through the cable cutter and the second fixture in a forward direction.

15. The cable processing system according to claim 14, wherein the one end of the cable clamped on the first fixture is processed by the first processing device while the other end of the cable segment clamped on the second fixture is processed by the second processing device.

16. The cable processing system according to claim 4, wherein each of the first rotator and the second rotator is a circular rotatable table, and the first rotator and the second rotator are rotatable about a common axis.

17. The cable processing system according to claim 16, wherein the first rotator is arranged directly above the second rotator, and the cable cutter is arranged between the cable feeding device and the second rotator, and in an initial position, the first fixture and the second fixture are aligned with the cable cutter to allow the fed cable to sequentially pass through the cable cutter, the second fixture and the first fixture.

18. The cable processing system according to claim 17, further comprising a plurality of pillars arranged on the first rotator, wherein the first rotator is adapted to, after the one end portion of the cable is processed, further rotate by a predetermined angle or a predetermined number of revolutions to wind the fed cable around the pillars.

19. The cable processing system according to claim 8, wherein after being wound around on the pillars, the fed cable is cut off by the cable cutter to obtain the cable segment having the predetermined length.

20. The cable processing system according to claim 19, wherein the first rotator and the second rotator are adapted to, after the fed cable is cut off by the cable cutter, rotate together to rotate the other clamped end of the cable segment to the second processing device.
